(19) United States
(12) Patent Application Publication
(10) Pub. No.: US 2003/0121585 A1
(43) Pub. Date: Jul. 3, 2003

(54) Decorative patterned articles and methods of making same

(76) Inventor: Michael L. Kukoff, Short Hills, NJ (US)

Correspondence Address: Kirschstein, Ottinger, Israel & Schiffmiller, P.C., 489 Fifth Avenue, New York, NY, 10017-6105, US

(21) Appl. No.: 10/034,492

(22) Filed: Dec. 28, 2001

(51) Int. Cl. B44C 1/00

(52) U.S. Cl. 156/63

(57) ABSTRACT

A decorative article is made by depositing first objects on an adhesive-coated, patterned area of an intermediate material, and by curing the adhesive to adhere the first objects together in the shape of the coated area. The first objects are then positioned over a selected area of a base material coated with an adhesive substance, the adhesive substance being exposed in an unselected area that is contiguous with the selected area. Second objects are deposited on the adhesive substance exposed in the unselected area. The adhesive substance is cured to adhere the second objects to the unselected area in contiguous relation to the first objects in the selected area to decorate the article. The objects have different characteristics, such as color, size, shape, and constituency.

### BACKGROUND OF THE INVENTION

1. Field of the Invention

This invention generally relates to decorative fabric articles having objects such as light-reflecting glitter flakes or discrete shaped plastic or glass pellets or beads thereon and, more particularly, to making such an article with a decorative pattern having contiguous areas affixed with different types of such objects thereon for an enhanced decorative effect.

2. Description of the Related Art

It is known from U.S. Pat. No. 3,377,184 to apply a tacky adhesive, preferably a polyvinylchloride plastisol, to a base fabric material in a desired pattern, and thereupon to apply or flock a plurality of bead-like pieces or pellets of synthetic plastic material onto the tacky adhesive. The excess pellets are then removed. The adhesive is cured by being heated. The plastic pellets are thus fixedly set on, and raised relative to, the fabric material. The adhesive may be applied thicker or thinner depending on its proposed use; see, for example, U.S. Pat. No. 3,582,440.

It is also known from U.S. Pat. No. 3,806,397 to apply a multitude of light-reflective flakes (also known as “glitter”) onto such an adhesive that has been applied to a release paper material. Each flake has an aluminum core that is coated over its entire periphery with a thin layer of a transparent polyvinylchloride. To cure the adhesive, heat is applied thereto and to the flakes on the adhesive. The flakes are essentially two-dimensional, planar and thin, e.g., on the order of 4 mils, and lie generally flat against the release material.

It is further known from U.S. Pat. No. 5,597,434 and U.S. Pat. No. 5,912,065 to place a foil sheet over a plurality of discrete shaped plastic pellets or beads and to fix portions of the foil sheet on upper surfaces of the pellets. Thereupon, the foil sheet is peeled off the pellets, leaving behind the fixed foil sheet portions that act as an irregular light-reflective surface.

Although generally satisfactory for their intended purpose, the known processes of making a decorative article typically adhere a single type of object to a desired area of the underlying material to be decorated. Thus, the object may be a bead or a flake, as described above, but not both on the same article in predetermined, desired, adjacent, contiguous areas that constitute a pattern.

As used herein, the “type” or characteristic of an object being referred to may involve beads of different materials such as plastic or glass or another material, beads of different colors such as red or blue or another color, beads of different sizes, beads of different shapes such as cylindrical or spherical or ovoidal or another shape; or flakes of different materials, colors, sizes, shapes, or optical reflectivities; or combinations of beads and flakes.

Since the known art is only capable of affixing a single type of object to a single area on an article, the ornamental and styling effects are limited. This is a particular problem when the article to be decorated is involved in fashion since fashion usually demands high styling, especially for dresses and dress handbags. To meet such fashion demands, the art could, perhaps, repetitively affix different objects in different areas on the article. However, such areas would have to be spaced well apart from each other since full object coverage in contiguous areas, especially in small areas of an intricate pattern cannot readily be achieved even with painstaking effort by skilled personnel.

### SUMMARY OF THE INVENTION

### OBJECTS OF THE INVENTION

It is a general object of this invention to provide a novel method of making a decorative article with contiguous areas of a pattern fully covered with different types of objects.

Another object of this invention is to decorate an article, such as a sheet material, with different objects such as beads or glitter flakes while avoiding the aforementioned difficulties and drawbacks of the prior art.

Still another object of this invention is to make a relatively lightweight, patterned material that can readily be used in wearing apparel.

Yet another object of this invention is to make a decorative article that can be folded, cut, rolled, sewn, draped and washed with ease, without the objects falling off the article during such procedures.

An additional object of this invention is to provide a patterned fabric from which the objects will not fall off, especially when worn or carried.

Another object of this invention is to provide a decorative patterned article whose contiguous areas to be decorated are fully covered with objects.

### FEATURES OF THE INVENTION

In keeping with these objects and others that will become apparent hereinafter, one feature of this invention resides, briefly stated, in a decorative article, and a method of, and an arrangement for, making the decorative article. A curable adhesive is coated on a coated area of an intermediate material. An uncoated area of the intermediate material is left free of the adhesive. Thereupon, first objects having a first type or characteristic are selected, and deposited on the coated area of the intermediate material. The adhesive is cured to adhere and hold the first objects together in a shape of the coated area.

Next, a curable adhesive substance is applied over a surface of a base material. The first objects held in the shape of the coated area are positioned over a selected area of the surface of the base material. The adhesive substance on the surface of the base material is exposed in an unselected area of the surface of the base material that is contiguous with the selected area.

Next, second objects, having a second type or characteristic different at least partly from the first objects, are selected and deposited on the adhesive substance that is exposed in the unselected area of the surface of the base material. The adhesive substance is cured to adhere the second objects to the unselected area in contiguous relation to the first objects in the selected area to decorate the article with objects of different characteristics.

Thus, in accordance with this invention, objects of different types and characteristics are affixed to the article in close, contiguous relationship to enhance the visual effect of the article. The first and the second objects can have different colors, sizes, shapes, and can be of different materials and constituencies. The decorative article has a richer, fuller appearance. The choice of patterns in which the objects can be arranged is virtually limitless.

In the preferred embodiment, the curable adhesive and the adhesive substance are the same, preferably a layer of a curable polyvinylchloride plastisol. The plastisol is cured by the application of heat or simply by air-drying.

In one embodiment, the coating step is performed by coating the curable adhesive on the intermediate material which is constituted as an apertured material formed with openings, such as a netting or mesh. Then, the positioning step is performed by laying the intermediate material directly over the adhesive substance, and enabling the adhesive substance to pass through the openings in the apertured material.

In another embodiment, the coating step is performed by coating the curable adhesive on the intermediate material which is constituted as a release sheet, in which case, the positioning step is performed by initially peeling the release sheet from the first objects prior to laying the first objects directly over the adhesive substance.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a portion of an intermediate material on which an adhesive has been coated in a desired pattern in accordance with one embodiment of a method of this invention;

FIG. 2 is an enlarged sectional view taken in the direction of the arrows 2-2 of FIG. 1;

FIG. 3 is a view analogous to FIG. 2 after first objects have been deposited on the adhesive of FIG. 1;

FIG. 4 is a perspective view of a portion of a base material on which an adhesive substance has been coated over a surface thereof;

FIG. 5 is an enlarged sectional view taken in the direction of the arrows 5-5 of FIG. 4;

FIG. 6 is an enlarged sectional view of the first objects on the intermediate material of FIG. 3 positioned on the base material of FIG. 5, leaving an exposed adhesive substance;

FIG. 7 is a view analogous to FIG. 6 after second objects have been deposited on the exposed adhesive substance of FIG. 6;

FIG. 8 is a cut-away view of the article with first and second objects covering contiguous areas of a pattern;

FIG. 9 is a view analogous to FIG. 3 depicting the peeling away of a release sheet from the first objects after the curing of the adhesive thereon in accordance with another embodiment of the method of this invention;

FIG. 10 is a view analogous to FIG. 6 depicting the positioning of the first objects on the adhesive-coated base material of FIG. 4 in accordance with the other embodiment; and

FIG. 11 is a view analogous to FIG. 7 depicting the first and second objects in contiguous areas on the base material in accordance with the other embodiment.

### DETAILED DESCRIPTION OF THE PREFERRED EMBODIMENTS

Referring now to the drawings, reference numeral 10 in FIG. 8 shows a portion of a decorative article manufactured in accordance with one embodiment of this invention. As described in detail below, the article bears a pattern of contiguous areas, each affixed and covered with objects of different types. As shown for exemplary purposes only, the pattern includes a flower having a head and a stem, the head having a circular center surrounded with petals. The stem and the petals represent one contiguous area, and the central region and the background represent another contiguous area.

The article 10 comprises a base material or layer 12. Advantageously, the base layer 12 is a fabric, either woven or non-woven, stretchable or non-stretchable, and preferably made from natural fibers, synthetic fibers, or combinations thereof. Preferably, the fabric is readily rolled, cut or sewn, so that it can be used for such applications as clothing, handbags, shoes, scarves, etc.

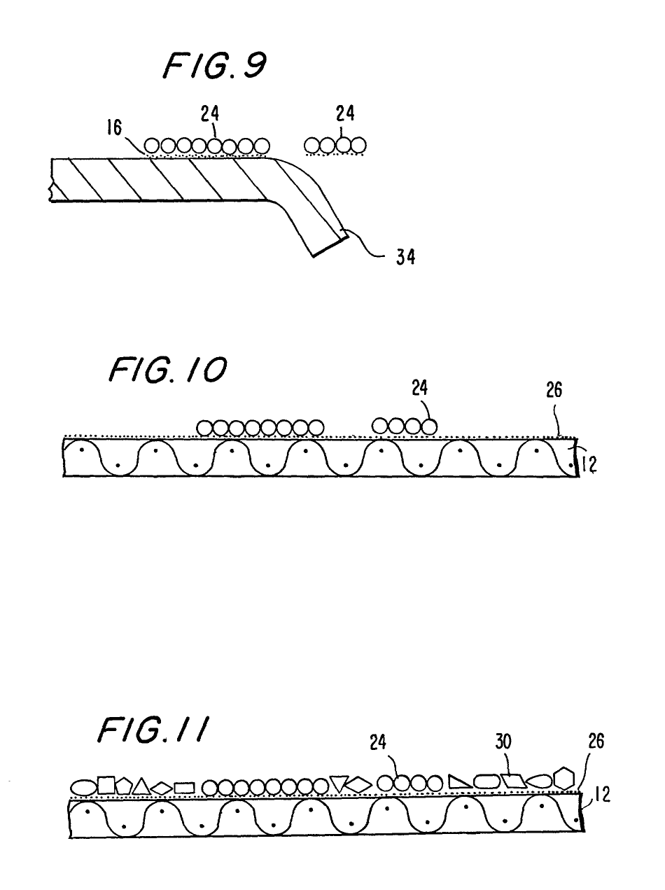

The article 10 also comprises an intermediate material or layer 14. The intermediate layer, in accordance with the embodiment of FIGS. 1-8, is an apertured material, netting, or mesh, and, in accordance with the embodiment of FIGS. 9-11, is a release layer, such as paper, either coated or uncoated with a release coating, as described below.

A layer of an adhesive 16 is applied, as shown in FIG. 1, over the intermediate layer 14 in any desired pattern or design. For exemplary purposes, the pattern is the flower described above. Preferably, the adhesive is a curable plastisol which is applied in a liquid state to the intermediate layer 14, either by hand or through a sieve 18, stencil, screen or analogous pattern-forming device to obtain the desired pattern. The wet adhesive penetrates slightly among the interstices of the intermediate layer 14.

Basically, the plastisols are composed of vinyl chloride resin particles dispersed in a plasticizer to which may be added stabilizers, pigments, gelling agents, mineral spirits (for thinning) and similar modifying additives. The formulation of plastisols usable with the present invention is quite wide. For example, based upon 100 parts by weight of vinyl chloride resin, the amount of plasticizer may vary from 50 parts to 200 parts and the amount of pigment, stabilizers and/or other modifying components may vary between 0 and 10 parts.

Typical formulations of plastisols, which may be used with the present invention, are as follows:

| Plastisols | Pounds |
|---|---|
| Polyvinylchloride resin (QYNV) | 100 |
| Diisooctylphthalate | 80 |
| Dibutyl tin maleate | 1 |
| Polyvinylchloride resin (Geon 121) | 100 |
| Dioctylphthalate | 80 |
| Barium-cadmium laurate | 1 |
| Polyvinylchloride resin (Exon 654) | 100 |
| Tri cresyl phosphate | 80 |
| Tri basic lead stearate | 2 |

Plastisols made according to the above formulations have the characteristics of pliability, flexibility and softness rather than the stiffness and hardness of other types of adhesives. They may be readily cut or sewn and then can withstand repeated washing or dry cleaning and have good, long-lasting wearing characteristics. If desired, these plastisols may contain pigmentation and may be thinned by mineral spirits. In this manner, the polyvinylchloride may be thinned to be free flowing for a flat appearance, or thickened so as to be viscous to give a high raised appearance where desired.

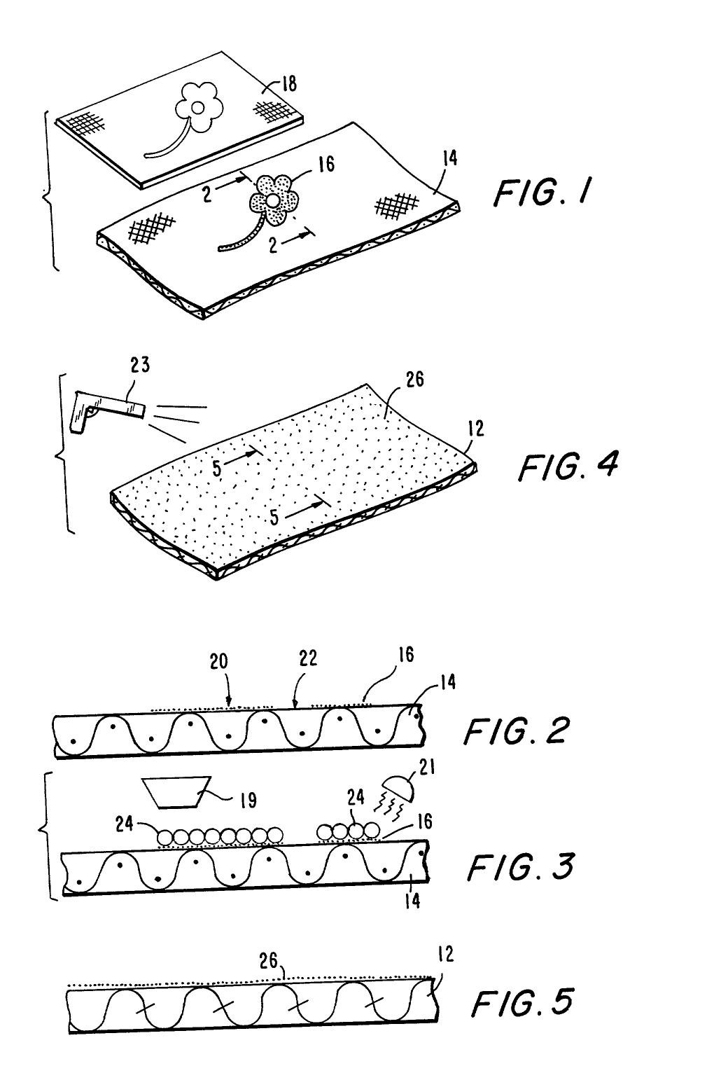

In the preferred embodiment, the plastisol is applied by being pressed through openings in the silk screen 18. The plastisol flows freely through the screen openings and will not clog them, thereby assuring that the screen can be re-used. The openings may have extremely fine detail and, hence, the adhesive pattern can be likewise very detailed. The pattern thus defines coated areas 20, as shown by stippling in FIG. 2, on the intermediate layer 14 to be decorated, as a well as unstippled, uncoated areas 22 free of the adhesive. Any pattern is intended to be covered by this invention.

A multitude of first objects 24 is deposited on the coated areas 20 of the intermediate material. As shown in FIG. 3, for exemplary purposes only, the first objects 24 are discrete pellets or beads of synthetic plastic material, each bead being shaped as an ovoid or a sphere and having a major dimension or diameter in a range from 1/32 to 1/16 of an inch.

The first objects 24 could also be light-reflective particles or glitter flakes that are lightweight, two dimensional, planar, thin, e.g., on the order of 4 mil, and small, e.g., on the order of ⅛ of an inch. The flakes are relatively softer than the beads so that they can be more easily cut or sewn through and will not scratch a wearer. They are also durable enough to maintain their shape throughout their life and can be washed at normal temperatures. The flakes are also relatively lighter than beads so that a large number may be placed on a piece of the intermediate layer 14 without unduly weighing it down.

Any choice or combination of colors, shapes, reflectivities, constituencies, and/or sizes of first objects may be utilized. The first objects of whatever type or characteristic are flocked onto the adhesive-coated pattern on the intermediate layer by hand or by using a suitable sieve 19. The first objects stick to the wet, tacky; adhesive-coated areas 20, and a pattern of first objects 24 corresponding to the pattern of the adhesive is obtained. The first objects cover up the plastisol to a large extent so that the plastisol does not show through.

After the first objects 24 are applied to the intermediate layer 14, the excess first objects on the uncoated areas 22 and which did not initially adhere to the intermediate layer are removed, for example, by shaking the intermediate layer or by using air or gas to blow off the excess first objects. Preferably, a vacuum cleaner or analogous suction device picks up the excess first objects. Only the excess first objects are removed, and the remaining first objects contact the plastisol for adherence to the intermediate layer 14.

In order to firmly fix the first objects to the intermediate layer, the plastisol is air-dried or heated to its curing point, i.e., the temperature at which the polyvinylchloride particles in the plastisol solidify. This is accomplished by placing the intermediate layer on a heated plate, or by placing it in an oven, or by using infrared heating lamps 21, or by using any other suitable heating means. All of the plastisols described above have a heat curing temperature in the range of between 300° F. to about 400° F., and all will adhere firmly to a fabric or other porous material. It is preferred that a plastisol which cures at 300° F. and above be used.

Next, a curable adhesive substance 26 is applied, as shown in FIGS. 4-5, in a liquid state over a surface of the base material 12. The adhesive substance 26 is preferably, but need not be, the same as the adhesive 16. The adhesive substance can be applied by various coating techniques, for example, by rollers, spray guns 23, or brushes that are used to obtain broad area coverage.

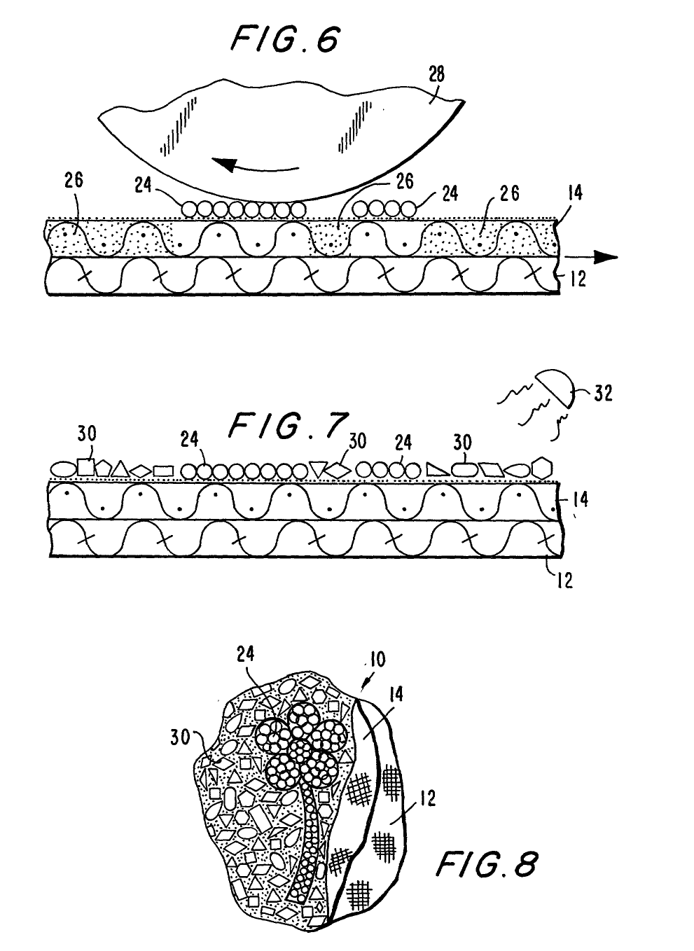

Thereupon, while the adhesive substance is still in the liquid state, the first objects 24, held in the shape of the coated area by virtue of being adhered together and by being supported by the intermediate material 14, are positioned on the coated base material 12. As shown in FIG. 6, this is accomplished by placing the intermediate material of FIG. 3 on the base material of FIG. 5. The adhesive substance 26 flows through the openings of the mesh-like intermediate material into the uncoated area 22 unoccupied by the first objects. The adhesive substance does not flow into the coated area 20 since it is blocked by the first objects therein. To enhance the flow, a pressure roller 28 urges the intermediate and base materials together. At the end of this step, the adhesive substance is exposed on the upper surface of the intermediate material 14 in all areas not already occupied by the first objects 24.

A multitude of second objects 30 is thereupon deposited over the still tacky, exposed adhesive substance 26 by hand or sieve, and adheres thereto. Excess second objects are removed in a manner analogous to that described above for the first objects. The adhesive substance is likewise cured, for example, by radiant heater 32 in a manner analogous to that described above.

The second objects 30 differ from the first objects 24 in at least one characteristic or type. The “type” or characteristic of an object being referred to may involve beads of different materials such as plastic or glass or another material, beads of different colors such as red or blue or another color, beads of different sizes, beads of different shapes such as cylindrical or spherical or ovoidal or another shape; or flakes of different materials, colors, sizes, shapes, constituencies, or optical reflectivities; or combinations of beads as the first objects and flakes as the second objects; or mixtures of beads and flakes as well as other objects.

FIG. 8 depicts the stem and the petals covered with the first objects 24, as well as the central region and the background covered with the second objects 30. The objects completely fill the respective contiguous areas that they occupy.

In accordance with the second embodiment mentioned above, the intermediate material may be, and in the preferred embodiment is, a release sheet 34 on which the adhesive 16 is coated in a pattern. The first objects 24 are deposited on the release sheet, and the adhesive 16 is cured as described above.

However, rather than placing the intermediate material directly on the base material 12 that is coated with the adhesive substance 26, the release sheet 34 is peeled away from the first objects as shown in FIG. 9, and the first objects themselves are directly positioned on the adhesive substance 26 as shown in FIG. 10. The area covered by the first objects is termed the selected area, and the area not covered by the first objects is termed the unselected area. The first objects are an interconnected mass held together by the adhesive 16.

As before, the second objects 30 are deposited on the unselected area, that is, the area having the exposed adhesive substance. After curing, the finished decorative article appears as in FIG. 11. The major difference between the two disclosed embodiments is that the intermediate material forms a part of the finished article for the first embodiment, whereas, the intermediate material constitutes no part of the finished article for the second embodiment.

It will be understood that each of the elements described above, or two or more together, also may find a useful application in other types of constructions differing from the types described above.

While the invention has been illustrated and described as embodied in decorative articles and a method of and an arrangement for making the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalents of the following claims.

What is claimed as new and desired to be protected by Letters Patent is set forth in the appended claims.

I claim:

1. A method of making a decorative article, comprising the steps of:
a) coating a curable adhesive on a coated area of an intermediate material, and leaving an uncoated area of the intermediate material free of the adhesive;
b) selecting first objects having a first characteristic, and depositing a plurality of the first objects on the coated area of the intermediate material;
c) curing the adhesive to adhere the first objects together in a shape of the coated area;
d) applying a curable adhesive substance over a surface of a base material;
e) positioning the first objects in the shape of the coated area over a selected area of the surface of the base material, and exposing the adhesive substance on the surface of the base material in an unselected area of the surface of the base material that is contiguous with the selected area;
f) selecting second objects having a second characteristic different at least partly from the first objects, and depositing a plurality of the second objects on the adhesive substance exposed in the unselected area of the surface of the base material; and
g) curing the adhesive substance to adhere the second objects to the unselected area in contiguous relation to the first objects in the selected area to decorate the article with objects of different characteristics.

2. The method of claim 1, wherein the coating step and the applying step are performed by applying respective layers of tacky plastisol on the intermediate material and the surface of the base material, respectively.

3. The method of claim 1, wherein the depositing steps are performed by flocking the first and the second objects on the intermediate material and the surface of the base material, respectively.

4. The method of claim 1, wherein the selecting steps are performed by choosing different materials for the first and the second objects.

5. The method of claim 1, wherein the selecting steps are performed by choosing different colors for the first and the second objects.

6. The method of claim 1, wherein the selecting steps are performed by choosing different shapes for the first and the second objects.

7. The method of claim 1, wherein the selecting steps are performed by choosing different sizes for the first and the second objects.

8. The method of claim 1, wherein the selecting steps are performed by choosing beads and flakes for the first and the second objects.

9. The method of claim 1, wherein the coating step is performed by coating the curable adhesive on the intermediate material formed with openings, and wherein the positioning step is performed by laying the intermediate material over the adhesive substance, and enabling the adhesive substance to pass through the openings.

10. The method of claim 1, wherein the coating step is performed by coating the curable adhesive on the intermediate material constituted as a release sheet, and wherein the positioning step is performed by initially peeling the release sheet from the first objects prior to laying the first objects over the adhesive substance.

11. A decorative article with contiguous areas covered with first and second objects of different types, comprising:
a) a cured adhesive on the contiguous areas of the article to be decorated;
b) a multitude of the first objects fully covering one of the contiguous areas, and adhered to the curable adhesive in the one contiguous area; and
c) a multitude of the second objects fully covering the other of the contiguous areas, and adhered to the curable adhesive in the other contiguous area.

12. An arrangement for making a decorative article, comprising:
a) means for coating a curable adhesive on a coated area of an intermediate material, and for leaving an uncoated area of the intermediate material free of the adhesive;
b) means for depositing a plurality of first objects having a first characteristic on the coated area of the intermediate material;
c) means for curing the adhesive to adhere the first objects together in a shape of the coated area;
d) means for applying a curable adhesive substance over a surface of a base material;
e) means for positioning the first objects in the shape of the coated area over a selected area of the surface of the base material, and for exposing the adhesive substance on the surface of the base material in an unselected area of the surface of the base material the surface of the base material that is contiguous with the selected area;
f) means for depositing a plurality of second objects having a second characteristic different at least partly from the first objects on the adhesive substance exposed in the unselected area of the surface of the base material; and
g) means for curing the adhesive substance to adhere the second objects to the unselected area in contiguous relation to the first objects in the selected area to decorate the article with objects of different characteristics.
